(19) United States
(12) Patent Application Publication
(10) Pub. No.: US 2022/0359924 A1
(43) Pub. Date: Nov. 10, 2022

(54) Battery Module

(71) Applicants: Hyundai Motor Company, Seoul (KR); Kia Corporation, Seoul (KR)

(72) Inventors: Hae Kyu Lim, Bucheon-si (KR); Tae Hyuck Kim, Asan-si (KR); Yu Ri Oh, Hwaseong-si (KR)

(73) Assignees: Hyundai Motor Company, Seoul (KR); Kia Corporation, Seoul (KR)

(21) Appl. No.: 17/871,166

(22) Filed: Jul. 22, 2022

Related U.S. Application Data
(63) Continuation-in-part of application No. 17/388,834, filed on Jul. 29, 2021.

(30) Foreign Application Priority Data
Sep. 15, 2020 (KR) 10-2020-0118578
Sep. 14, 2021 (KR) 10-2021-0122616

(51) Int. Cl. H01M 10/48; H01M 50/233; H01M 50/249; H01M 50/264

(52) U.S. Cl. CPC H01M 10/486; H01M 10/482; H01M 50/233; H01M 50/249; H01M 50/264; H01M 2220/20

(57) ABSTRACT

An embodiment battery module includes a plurality of battery cells stacked in a first direction to define a stacked structure, a pair of end plates in surface contact with opposite ends of the stacked structure in the first direction, a plurality of clamps configured to connect the end plates to each other at opposite sides of the battery cells and configured to apply surface pressure between the battery cells, an upper temperature sensor provided at an upper portion of one of the end plates and configured to measure a temperature of the battery cells at a first location between the end plate and the battery cells, and a lower temperature sensor provided at a lower portion of the end plate and configured to measure the temperature of the battery cells at a second location between the end plate and the battery cells.

### CROSS-REFERENCE TO RELATED APPLICATIONS

This application is a continuation-in-part of U.S. patent application Ser. No. 17/388,834, filed on Jul. 29, 2021, and claims the benefit of Korean Patent Application No. 10-2021-0122616, filed on Sep. 14, 2021, and Korean Patent Application No. 10-2020-0118578, filed on Sep. 15, 2020, which applications are hereby incorporated herein by reference.

### TECHNICAL FIELD

The present invention relates generally to a battery module mounted on a vehicle.

### BACKGROUND

A high voltage battery is mounted on an electric vehicle or a hybrid vehicle. The high voltage battery is composed of a plurality of battery modules, and each battery module includes a plurality of battery cells.

As lifespan and performance of the battery module as described above are greatly affected by temperature, and in order to allow the battery module to maintain a proper temperature, preferably, the temperature of the battery module is measured and proper cooling suitable to maintain the temperature is performed.

The foregoing described as the battery module is intended merely to aid in the understanding of the background of the present invention, and is not intended to mean that the present invention falls within the purview of the related art that is already known to those skilled in the art.

### SUMMARY

Accordingly, embodiments of the present invention provide a battery module configured such that even surface pressure is applied to battery cells constituting the battery module, thus to contribute to secure the durability of the battery module, and the temperature of the battery module is measured with sufficient plausibility and representation to allow the temperature control of the battery module to be precisely performed, thus to ultimately and significantly contribute to the improvement in the durability of the battery module.

According to one embodiment of the present invention, there is provided a battery module including a plurality of battery cells stacked in a first direction, a pair of end plates being in surface contact with opposite ends in the first direction of a stacked structure consisting of the plurality of stacked battery cells, a plurality of clamps configured to connect the end plates to each other at opposite sides of the stacked battery cells and configured to apply surface pressure between the stacked battery cells, an upper temperature sensor provided at an upper portion of one of the end plates and configured to measure temperature of the battery cells at a location between the end plate and the battery cells, and a lower temperature sensor provided at a lower portion of the end plate and configured to measure temperature of the battery cells at a location between the end plate and the battery cells.

The clamps may include a first clamp of which opposite ends may be respectively coupled to upper portions of the end plates and a second clamp of which opposite ends may be respectively coupled to lower portions of the end plates.

The first clamp and the second clamp may be respectively coupled to center portions of the end plates in a second direction, the second direction being perpendicular to a first direction of the end plates, the upper temperature sensor may be provided at a location close to the first clamp, and the lower temperature sensor may be provided at a location close to the second clamp.

The upper temperature sensor may be provided at a location within 10% or less of a second-directional length of the end plate from the first clamp, and the lower temperature sensor may be provided at a location within 10% or less of the second-directional length of the end plate from the second clamp.

The upper temperature sensor and the lower temperature sensor may be respectively provided at opposite portions on a virtual straight line connecting the first clamp to the second clamp.

The upper temperature sensor and the lower temperature sensor may be located at center portions in the second direction perpendicular to the first direction of one of the end plates, the first clamp may be coupled to a location adjacent to the upper temperature sensor, and the second clamp may be coupled to a location adjacent to the lower temperature sensor.

The first clamp may be coupled to a location within 10% or less of a second-directional length of the end plate from the upper temperature sensor, and the second clamp may be located at a location within 10% or less of the second-directional length of the end plate from the lower temperature sensor.

The first clamp and the second clamp may be respectively coupled to opposite portions on a virtual straight line connecting the upper temperature sensor to the lower temperature sensor.

Each of the end plates may include an inner plate being in surface contact with the battery cells, and an outer plate coupled to the clamps while covering an outer surface of the inner plate and configured to supply the surface pressure to the battery cells by using a tensile force supplied from the clamps.

The outer plate may have bent portions at upper and lower portions thereof, the bent portions providing empty spaces into which the upper temperature sensor and the lower temperature sensor may be inserted between the end plate and the battery cells, and the inner plate may have cut portions formed at upper and lower portions thereof at locations corresponding to the bent portions, the cut portions being configured to allow the upper temperature sensor and the lower temperature sensor to be in contact with the battery cells.

According to embodiments of the present invention, the battery module is configured such that even surface pressure is applied to the battery cells constituting the battery module to contribute to secure the durability of the battery module, and the temperature of the battery module is measured with sufficient plausibility and representation. Therefore, the temperature control of the battery module can be precisely performed, thus ultimately and significantly contributing to the improvement in the durability of the battery module.

### BRIEF DESCRIPTION OF THE DRAWINGS

The above and other objectives, features, and other advantages of embodiments of the present invention will be more clearly understood from the following detailed description when taken in conjunction with the accompanying drawings, in which:

FIG. 1 is a perspective view showing a battery module according to a first embodiment of the present invention;

FIG. 2 is an exploded-perspective view showing the battery module in FIG. 1;

FIG. 3 is a view showing coupling between a stacked structure consisting of stacked battery cells and end plates in FIG. 2;

FIG. 4 is a view showing comparison between an outer surface and an inner surface (shown in upper and lower sides) of the end plate according to the first embodiment of the present invention;

FIG. 5 is a view showing an empty space into which an upper temperature sensor according to the first embodiment of the present invention is inserted;

FIG. 6 is a view showing clamps, the upper temperature sensor, and a lower temperature sensor, in an installed state, according to the first embodiment of the present invention;

FIG. 7 is a view showing clamps, an upper temperature sensor, and a lower temperature sensor, in an installed state, according to a second embodiment of the present invention; and

FIG. 8 is a perspective view showing a battery module according to the second embodiment of the present invention.

### DETAILED DESCRIPTION OF ILLUSTRATIVE EMBODIMENTS

In the following description, the structural or functional description specified to exemplary embodiments according to the concept of the present invention is intended to describe the exemplary embodiments, so it should be understood that the present invention may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present invention are not limited to the embodiments which will be described hereinbelow with reference to the accompanying drawings, but all modifications, equivalents, and substitutions are included in the scope and spirit of the invention.

It will be understood that, although the terms first and/or second, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

The terminology used herein is for the purpose of describing particular embodiments only and is not intended to limit the present invention. Singular forms are intended to include plural forms unless the context clearly indicates otherwise. It will be further understood that the terms “comprises” or “have” used in this specification specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which the present invention belongs. It must be understood that the terms defined by the dictionary are identical with the meanings within the context of the related art, and they should not be ideally or excessively formally defined unless the context clearly dictates otherwise.

Exemplary embodiments will be described hereafter in detail with reference to the accompanying drawings. Like reference numerals given in the drawings indicate like components.

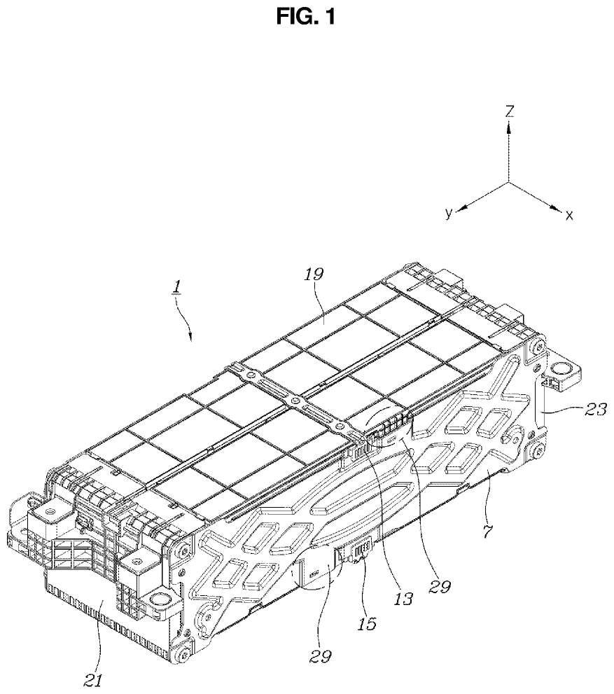

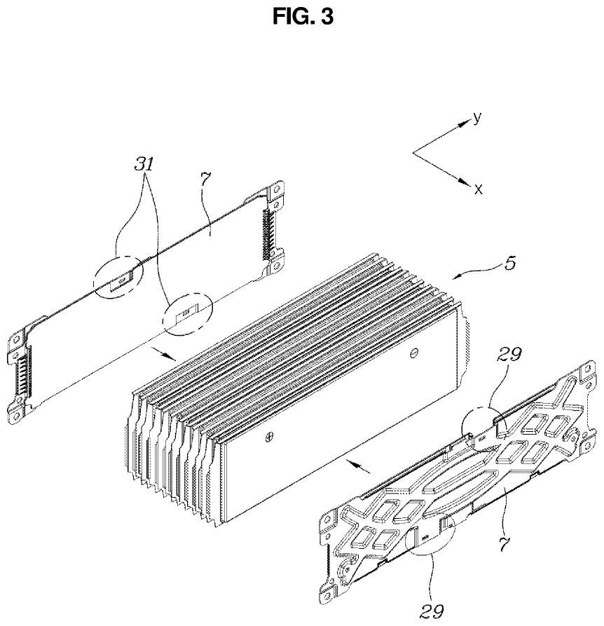

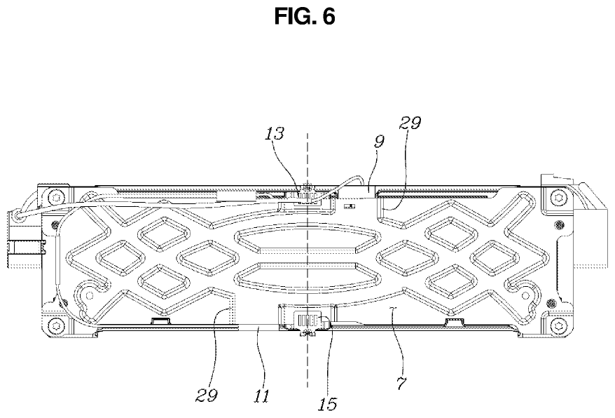

Referring to FIGS. 1 to 8, according to embodiments of the present invention, a battery module 1 includes a plurality of battery cells 3 stacked in a first direction X, a pair of end plates 7 being in surface contact with opposite ends in the first direction X of a stacked structure 5 formed as the battery cells 3 are stacked, a plurality of clamps 13 and 15 connecting the end plates 7 at opposite sides to each other to apply a surface pressure between the stacked battery cells 3, an upper temperature sensor 9 provided at an upper portion of one of the end plates 7 and measuring the temperature of the battery cells 3 at a location between the end plate 7 and the battery cells 3, and a lower temperature sensor 11 provided at a lower portion of the end plate 7 and measuring the temperature of the battery cells 3 at a location between the end plate 7 and the battery cells 3.

The battery module 1 is configured such that the stacked structure 5 formed as the battery cells 3 are stacked is compressed by a tensile force supplied by the clamps between the end plates 7 at opposite ends of the stacked structure 5. The upper temperature sensor 9 and the lower temperature sensor 11 are provided between the end plate 7 and the battery cells 3 and respectively measure upper and lower temperatures of the battery cells 3, so that the temperature of the battery module 1 may be precisely obtained.

The clamps include a first clamp 13 of which opposite ends are respectively coupled to upper portions of the end plates 7 and a second clamp 15 of which opposite ends are respectively coupled to lower portions of the end plates 7.

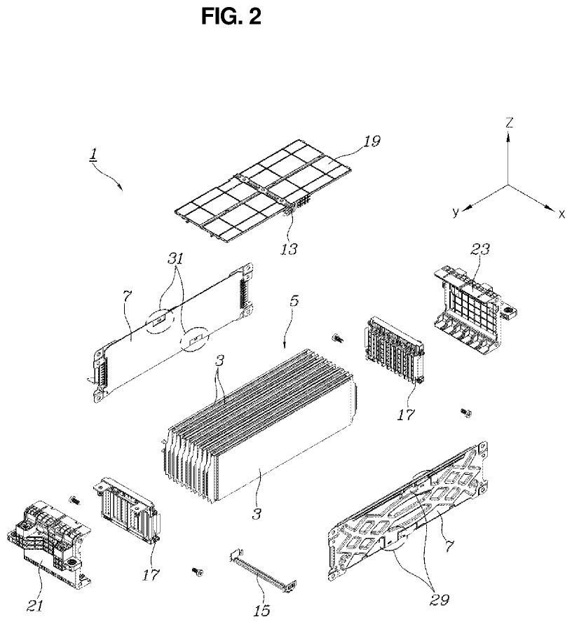

For example, as shown in FIG. 2, in the battery module 1, the battery cells 3 are stacked in the first direction X to constitute the stacked structure 5, the end plates 7 are in surface contact with the opposite ends of the stacked structure 5, busbar assemblies 17 are coupled to opposite ends in a second direction Y of the battery module 1, a first cover 19 is mounted to an upper portion in a third direction Z of the battery module 1, and a second cover 21 and a third cover 23 are respectively provided outside the busbar assemblies 17.

The first clamp 13 is coupled to the battery module while covering an upper portion of the first cover 19 and opposite ends thereof are bent to cover outer portions of the end plates 7.

Each of the end plates 7 includes an inner plate 25 being in surface contact with the battery cells 3, and an outer plate 27 covering an outer surface of the inner plate 25 and coupled to the clamps to apply the surface pressure of the stacked battery cells 3 with the tensile force supplied by the clamps.

Therefore, it is preferable that the outer plate 27 is configured to have relatively large rigidity compared to the inner plate 25, and thus evenly transmits the tensile force supplied by the clamps to the battery cells 3 stacked inside the battery module, so that an even surface pressure may be applied to the stacked battery cells 3.

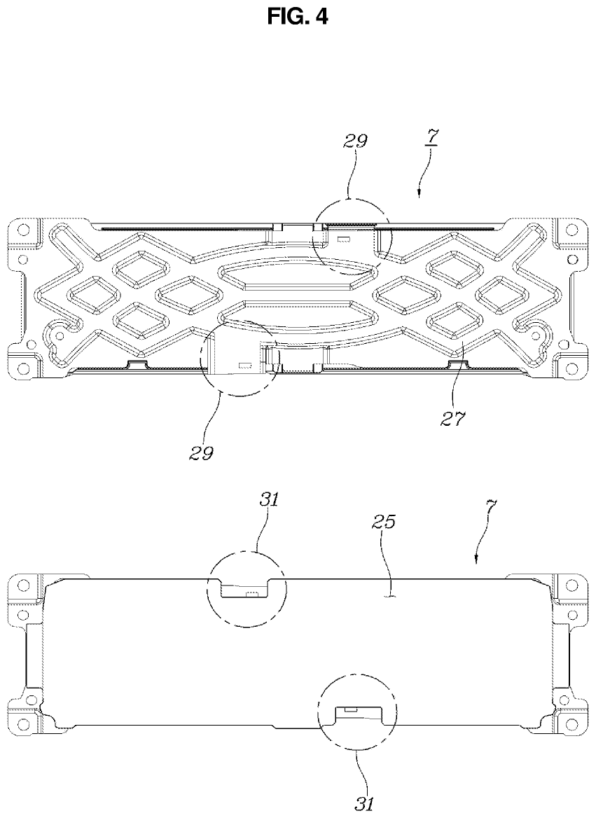

As shown in FIG. 4, the outer plate 27 has bent portions 29 formed at upper and lower portions thereof. The bent portions 29 provide empty spaces into which the upper temperature sensor 9 and the lower temperature sensor 11 are inserted between the end plate and the battery cells 3.

Furthermore, the inner plate 25 has cut portions 31 at upper and lower portions thereof corresponding to the bent portions 29, so that the upper temperature sensor 9 and the lower temperature sensor 11 may be in contact with the battery cells 3.

For example, in FIG. 4, an upper bent portion 29 and an upper cut portion 31 are overlapped with each other and a lower bent portion 29 and a lower cut portion 31 are overlapped with each other, whereby empty spaces T into which the upper temperature sensor 9 and the lower temperature sensor 11 are inserted are provided.

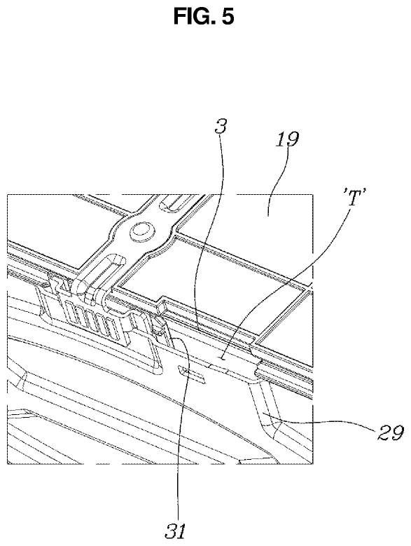

Therefore, when the upper temperature sensor 9 and the lower temperature sensor 11 are respectively inserted into the empty spaces T formed by the bent portions 29 and the cut portions 31 as shown in FIG. 5, the upper temperature sensor 9 may be in contact with an upper side surface of an outmost one of the battery cells 3 in the stacked structure 5, and the lower temperature sensor 11 may be in contact with a lower side surface of the battery cell 3, whereby the precise upper and lower temperatures of the battery cells 3 may be individually obtained.

According to a first embodiment shown in FIGS. 1 to 6, the first clamp 13 and the second clamp 15 are coupled to center portions in the second direction Y, which is perpendicular to the first direction X, of the end plate 7. The upper temperature sensor 9 is provided at a location adjacent to the first clamp 13. The lower temperature sensor 11 is provided at a location adjacent to the second clamp 15.

The upper temperature sensor 9 is located at a location within 10% or less of the second-directional length of the end plate 7 from the first clamp 13. The lower temperature sensor 11 is located at a location within 10% or less of the second-direction length of the end plate 7 from the second clamp 15.

The upper temperature sensor 9 and the lower temperature sensor 11 are located adjacent to the first clamp 13 and the second clamp 15 as described above.

As described above, when the first clamp 13 and the second clamp 15 are coupled to the center portions in the second direction Y of the end plate 7, the surface pressure applied to the battery cells 3 stacked between the end plates 7 is evenly distributed on the whole areas of the battery cells 3, resulting in improvement in the durability of the battery cells 3.

Furthermore, when the upper temperature sensor 9 and the lower temperature sensor 11 are located adjacent to the first clamp 13 and the second clamp 15 as described above, the upper temperature sensor 9 and the lower temperature sensor 11 respectively measure the upper central temperature and the lower central temperature of the battery cells 3, so that the whole temperature of the battery cells 3 may be obtained with a plausibly representative state.

The upper temperature sensor 9 and the lower temperature sensor 11 may be provided at locations that are opposite to each other on a virtual straight line connecting the first clamp 13 to the second clamp 15.

Both the upper temperature sensor 9 and the lower temperature sensor 11 may be provided at any one side on the virtual straight line, but the upper temperature sensor 9 and the lower temperature sensor 11 may be located at the opposite portions on the virtual straight line as described above to improve the plausibility and representation of the temperature measured in the battery cells 3.

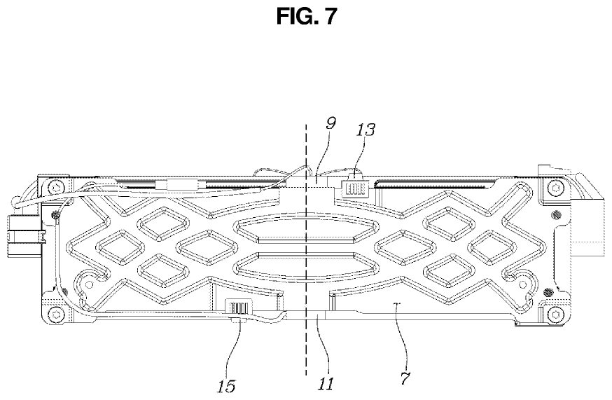

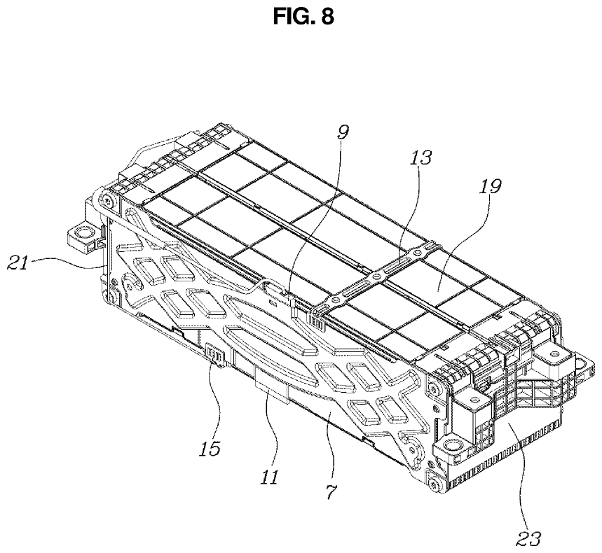

Meanwhile, according to a second embodiment shown in FIGS. 7 and 8, the upper temperature sensor 9 and the lower temperature sensor 11 are provided at center portions in the second direction Y, which is perpendicular to the first direction X, of the end plate 7, the first clamp 13 is coupled to a location adjacent to the upper temperature sensor 9, the second clamp 15 is coupled to a location adjacent to the lower temperature sensor 11, and other components are the same as the components of the battery module according to the first embodiment.

Unlike the first embodiment, as the upper temperature sensor 9 and the lower temperature sensor 11 are provided at the center portions in the second direction Y of the end plate 7, the temperature measured in the battery cells 3 is maximized in the plausibility and representation, and as the first clamp 13 and the second clamp 15 are coupled to the locations adjacent to the center portions in the second direction Y of the end plates 7 as possible, even surface pressure to the battery cells 3 is promoted.

The first clamp 13 may be provided at a location within 10% or less of the second-directional length of the end plate 7 from the upper temperature sensor 9. The second clamp 15 may be provided at a location within 10% or less of the second-directional length of the end plate 7 from the lower temperature sensor 11.

If possible, the first clamp 13 and the second clamp 15 are coupled to the end plate 7 adjacent to the center in the second direction Y.

The first clamp 13 and the second clamp 15 are coupled to opposite portions of the end plate 7 on a virtual straight line connecting the upper temperature sensor 9 to the lower temperature sensor 11, so that the surface pressure of the battery cells 3 is evenly distributed on opposite sides of the battery cells 3.

As described above, according to embodiments of the present invention, the surface pressure of the battery cells 3 constituting the battery module 1 is evenly distributed so that the durability of the battery module 1 can be secured, and the temperature of the battery module 1 is obtained while securing sufficient plausibility and representation, so that the temperature of the battery module 1 can be precisely controlled, and ultimately, the durability of the battery module 1 can be significantly improved.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A battery module comprising:
a plurality of battery cells stacked in a first direction to define a stacked structure;
a pair of end plates in surface contact with opposite ends of the stacked structure in the first direction;
a plurality of clamps configured to connect the end plates to each other at opposite sides of the battery cells and configured to apply surface pressure between the battery cells;
an upper temperature sensor provided at an upper portion of one of the end plates and configured to measure a temperature of the battery cells at a first location between the end plate and the battery cells; and
a lower temperature sensor provided at a lower portion of the end plate and configured to measure a temperature of the battery cells at a second location between the end plate and the battery cells.

2. The battery module of claim 1, wherein the clamps comprise:
a first clamp having opposite ends respectively coupled to the upper portions of the end plates; and
a second clamp having opposite ends respectively coupled to the lower portions of the end plates.

3. The battery module of claim 2, wherein:
the first clamp and the second clamp are respectively coupled to center portions of the end plates in a second direction, the second direction being perpendicular to a first direction of the end plates;
the upper temperature sensor is provided at a location close to the first clamp; and
the lower temperature sensor is provided at a location close to the second clamp.

4. The battery module of claim 3, wherein:
the upper temperature sensor is provided at a location within 10% or less of a second-directional length of the end plate from the first clamp; and
the lower temperature sensor is provided at a location within 10% or less of the second-directional length of the end plate from the second clamp.

5. The battery module of claim 3, wherein the upper temperature sensor and the lower temperature sensor are respectively provided at opposite portions on a virtual straight line connecting the first clamp to the second clamp.

6. The battery module of claim 2, wherein:
the upper temperature sensor and the lower temperature sensor are located at center portions in the second direction perpendicular to the first direction of one of the end plates;
the first clamp is coupled to a location adjacent to the upper temperature sensor; and
the second clamp is coupled to a location adjacent to the lower temperature sensor.

7. The battery module of claim 6, wherein:
the first clamp is coupled to a location within 10% or less of a second-directional length of the end plate from the upper temperature sensor; and
the second clamp is coupled to a location within 10% or less of the second-directional length of the end plate from the lower temperature sensor.

8. The battery module of claim 6, wherein the first clamp and the second clamp are respectively coupled to opposite portions on a virtual straight line connecting the upper temperature sensor to the lower temperature sensor.

9. The battery module of claim 1, wherein each of the end plates comprises:
an inner plate in surface contact with the battery cells; and
an outer plate coupled to the plurality of clamps while covering an outer surface of the inner plate.

10. The battery module of claim 9, wherein the outer plate is configured to supply the surface pressure to the battery cells by using a tensile force supplied from the plurality of clamps.

11. The battery module of claim 9, wherein:
the outer plate includes bent portions at upper and lower portions thereof, the bent portions defining empty spaces into which the upper temperature sensor and the lower temperature sensor are inserted between the end plate and the battery cells; and
the inner plate includes cut portions formed at upper and lower portions thereof at locations corresponding to the bent portions, the cut portions being configured to allow the upper temperature sensor and the lower temperature sensor to be in contact with the battery cells.

12. A vehicle comprising:
a vehicle body; and
a battery module mounted in the vehicle body, wherein the battery module comprises:
a plurality of battery cells stacked in a first direction to define a stacked structure;
a pair of end plates in surface contact with opposite ends of the stacked structure in the first direction;
a plurality of clamps connecting the end plates to each other at opposite sides of the battery cells and configured to apply surface pressure between the battery cells;
an upper temperature sensor provided at an upper portion of one of the end plates and configured to measure a temperature of the battery cells at a first location between the end plate and the battery cells; and
a lower temperature sensor provided at a lower portion of the end plate and configured to measure the temperature of the battery cells at a second location between the end plate and the battery cells.

13. The vehicle of claim 12, wherein the clamps comprise:
a first clamp having opposite ends respectively coupled to the upper portions of the end plates; and
a second clamp having opposite ends respectively coupled to the lower portions of the end plates.

14. The vehicle of claim 13, wherein:
the first clamp and the second clamp are respectively coupled to center portions of the end plates in a second direction, the second direction being perpendicular to a first direction of the end plates;
the upper temperature sensor is provided at a location close to the first clamp; and
the lower temperature sensor is provided at a location close to the second clamp.

15. The vehicle of claim 14, wherein:
the upper temperature sensor is provided at a location within 10% or less of a second-directional length of the end plate from the first clamp; and
the lower temperature sensor is provided at a location within 10% or less of the second-directional length of the end plate from the second clamp.

16. The vehicle of claim 14, wherein the upper temperature sensor and the lower temperature sensor are respectively provided at opposite portions on a virtual straight line connecting the first clamp to the second clamp.

17. The vehicle of claim 13, wherein:
the upper temperature sensor and the lower temperature sensor are located at center portions in the second direction perpendicular to the first direction of one of the end plates;
the first clamp is coupled to a location adjacent to the upper temperature sensor; and
the second clamp is coupled to a location adjacent to the lower temperature sensor.

18. The vehicle of claim 17, wherein:
the first clamp is coupled to a location within 10% or less of a second-directional length of the end plate from the upper temperature sensor; and
the second clamp is coupled to a location within 10% or less of the second-directional length of the end plate from the lower temperature sensor.

19. The vehicle of claim 17, wherein the first clamp and the second clamp are respectively coupled to opposite portions on a virtual straight line connecting the upper temperature sensor to the lower temperature sensor.

20. The vehicle of claim 12, wherein:
each of the end plates comprises:
an inner plate in surface contact with the battery cells; and
an outer plate coupled to the plurality of clamps while covering an outer surface of the inner plate, wherein the outer plate is configured to supply the surface pressure to the battery cells by using a tensile force supplied from the plurality of clamps;
the outer plate includes bent portions at upper and lower portions thereof, the bent portions defining empty spaces into which the upper temperature sensor and the lower temperature sensor are inserted between the end plate and the battery cells; and
the inner plate includes cut portions formed at upper and lower portions thereof at locations corresponding to the bent portions, the cut portions being configured to allow the upper temperature sensor and the lower temperature sensor to be in contact with the battery cells.
